(19) United States
(12) Patent Application Publication
(10) Pub. No.: US 2010/0123074 A1
(43) Pub. Date: May 20, 2010

(54) DETECTION METHOD OF AIRBORNE NOXIOUS SUBSTANCE

(75) Inventors: Jung Ki SUH, Daejeon (KR); Namgoo KANG, Daejeon (KR); Jin Bok LEE, Daejeon (KR)

Correspondence Address: CANTOR COLBURN, LLP, 20 Church Street, 22nd Floor, Hartford, CT, 06103, US

(73) Assignee: KOREA RESEARCH INSTITUTE OF STANDARDS AND SCIENCE, Daejeon (KR)

(21) Appl. No.: 12/613,027

(22) Filed: Nov. 5, 2009

(30) Foreign Application Priority Data
Nov. 17, 2008 (KR) 10-2008-0113787

(51) Int. Cl. H01J 49/26

(52) U.S. Cl. 250/282

(57) ABSTRACT

Provided is a method for detecting an airborne noxious substance using radio-frequency inductive coupled plasma-mass spectroscopy (ICP-MS). The method includes: supplying a gas to be detected to a radio-frequency inductive coupled plasma; supplying oxygen gas to the gas introduced to the plasma to generate the oxide ion of a noxious element; and detecting the mass of the oxide ion of the noxious element. The method requires no separate pretreatment for detecting an airborne noxious substance, uses the ambient air itself as an analyte, and allows detection of the existence and amount of a noxious substance with high accuracy in a rapid and simple manner.

### CROSS-REFERENCE(S) TO RELATED APPLICATIONS

The present invention claims priority of Korean Patent Application No. 10-2008-0113787, filed on 17 Nov. 2008, which is incorporated herein by reference.

### BACKGROUND OF THE INVENTION

1. Field of the Invention

The present invention relates to a method for detecting the existence and amount of an airborne noxious substance; and, more particularly, to a method for detecting an airborne noxious substance, which uses the ambient air itself as an analyte without any separate pretreatment, detects a noxious substance accurately, reproducibly and rapidly within several minutes, and allows detection of a trace amount of noxious substance and real time detection of an airborne noxious substance.

2. Description of Related Art

Airborne noxious substances may be broadly classified into particulate substances, gaseous substances and heavy metal substances. Among those, gaseous substances and heavy metal substances may significantly affect the human bodies and environment even they are present in a trace amount. Therefore, careful detection and control of such noxious substances is required.

For example, the permissible exposure limits of arsine (AsH₃), a typical arsenic compound, established by National Institute for Occupational Safety and Health (NIOSH) and Occupational Safety and Health Association (OSHA) are 0.002 mg m⁻³ during 15 min and 0.2 mg m⁻³ (0.05 ppmv), respectively. The American Committee of Government in Health (ACGIH) suggests a more strict exposure limit of 0.016 mg m⁻³ (0.005 ppmv).

In general, arsenic compounds have been used as preservatives, insecticides, rodenticides, etc. Arsine has been frequently used in doping operation for semiconductor fabrication processes. Since arsine is highly toxic, human exposure to arsine in workplace poses a potential health hazard that may result in severe toxic effects such as arsenic intoxication.

In addition, processes using materials containing arsenic or arsenic compounds as impurities may cause accidental on-site generation of arsenic compounds, even if they use no arsenic compounds directly. Particularly, processes using hydrogen gas have some possibilities for arsine generation.

Since early 1980s, many techniques for detection of arsine in gases including the ambient air have been developed. It has been first suggested that airborne arsine gas can be trapped on a silver nitrate filter or can be adsorbed onto activated carbon. Such “indirect” detection methods based on trapping or adsorption have been conventionally used to detect arsine.

More particularly, the NIOSH method 6001 includes adsorption of arsine using a solid sorbent tube with activated carbon, and desorption/dissolution using dilute nitric acid, followed by analysis using graphite furnace-atomic absorption spectroscopy (GF-AAS). The NIOSH method 6001 indicates its collection efficiency of 89% or less. The overall detection accuracy is as low as ±23.2%.

The OSHA method 1D-105 includes adsorption of arsine using a sampling tube with a cellulose ester filter and activated carbon, and desorption/dissolution using dilute nitric acid/nickel solution, followed by analysis using heated graphite atomizer-atomic absorption spectroscopy (HGA-AAS). However, this method has a significant drawback of a low overall detection accuracy of ±20%.

The above methods according to the related art are by nature limited in accurate analysis of arsine, because they show low detection accuracies, require time-consuming sample pretreatment for detecting an airborne noxious substance, resulting in a failure in carrying out real time monitoring for the ambient air, and are not capable of direct analysis of the ambient air itself.

### SUMMARY OF THE INVENTION

An embodiment of the present invention is directed to providing a method for detecting the existence and amount of an airborne noxious substance, which uses the ambient air itself as an analyte without any separate pretreatment, detects a noxious substance accurately, reproducibly and rapidly within several minutes, and allows detection of a trace amount of noxious substance and real time detection of an airborne noxious substance.

To achieve the object of the present invention, the present invention provides a method for detecting an airborne noxious substance using radio-frequency inductive coupled plasma-mass spectroscopy (ICP-MS), the method including:

supplying a gas to be detected to a radio-frequency inductive coupled plasma;

supplying oxygen gas to the gas introduced to the plasma to generate the oxide ion of a noxious element; and

detecting the mass of the oxide ion of the noxious element.

Preferably, when generating the oxide ion of the noxious element, the gas to be detected is allowed to be in contact with the plasma, transferred to a zone, in which no plasma is formed, by a carrier gas, and is allowed to react with the oxygen gas supplied thereto so that the oxide ion of the noxious element is generated.

The term ‘oxide ion of the noxious element’ means the ion including oxygen combined with an element (noxious element) forming the noxious substance contained in the gas.

The noxious substance contained in the gas includes arsenic, an arsenic compound, a heavy metal or a heavy metal compound. In this context, the oxide ion of the noxious element includes the oxide ion of arsenic or a heavy metal element.

More particularly, the noxious substance contained in the gas includes a heavy metal or heavy metal compound, and the oxide ion of the noxious element includes the oxide ion of a heavy metal element. The heavy metal includes mercury, cadmium, lead, copper, chrome, nickel, vanadium or a radioactive element of thorium series, uranium series and actinium series. The oxide ion of the noxious element includes mercury oxide ion, cadmium oxide ion, lead oxide ion, copper oxide ion, chrome oxide ion, nickel oxide ion, vanadium oxide ion, oxide ion of thorium series, oxide ion of uranium series or oxide ion of actinium series.

More particularly, the noxious substance contained in the gas is an arsenic compound, including arsenic and arsenic hydride, and the oxide ion of the noxious element is AsO⁺.

The gas to be detected is the ambient atmosphere, from which the existence and amount of a noxious substance is determined. The method in accordance with the present invention requires no separate pretreatment for detecting an airborne noxious substance, and uses the ambient air itself as an analyte. Therefore, it is possible to determine the existence and amount of a noxious substance accurately in a rapid and simple manner.

In addition, the method in accordance with the present invention is carried out in a continuous mode by repeating the above-described operations, and thus allows the real time detection of a noxious substance contained in the gas.

This results from the fact that the method in accordance with the present invention uses the ambient air itself as an analyte. The method in accordance with the present invention requires no time for the sample pretreatment, and the detection is completed within several minutes after the analyte is introduced to the plasma. Since the gaseous sample itself is analyzed by the method, the gas (preferably the ambient air) to be detected is supplied continuously to the plasma, oxygen is supplied continuously thereto, and then the mass of the oxide ion of the noxious element is determined through a mass spectrometer provided in the ICP-MS system in the form of a time interval. In this manner, it is possible to perform real time quantitative determination of a noxious substance contained in the gas (preferably, the ambient air) to be detected.

Herein, the radio-frequency inductive coupled plasma is one generated by a plasma-generating gas (including a plasma generation auxiliary gas) provided in a general radio-frequency ICP-MS system. In this context, the detection of the mass of the oxide ion of the noxious element refers to the acquisition of detection signals depending on m/z values (mass/ion charge) through the use of a mass spectrometer provided in a general radio-frequency ICP-MS system. Particularly, detection signals are acquired at the m/z value corresponding to the ionized noxious element combined with oxygen.

More particularly, the oxide ion of the noxious element is AsO⁺, and the detection is carried out based on an m/z value of 90.9165. In this manner, it is possible to perform real time detection of the existence and amount of an arsenic compound rapidly without any pretreatment for the detection. It is also possible to determine the amount of the arsenic compound accurately while avoiding the interference caused by other substances.

Preferably, the oxygen gas for generating the oxide ion of the noxious element is supplied at a flow rate of 0.2-0.5 mL/min, more preferably 0.3-0.4 mL/min. Such a flow rate allows the noxious element contained in the gas introduced into the plasma to react with oxygen, thereby generating the oxide ion rapidly, and prevents degradation of detection quality caused by collision.

Preferably, the gas to be detected is supplied with a carrier gas.

The carrier gas is used in order to control the introduction of the gas to be detected independently from the flow rate of the fluid introduced to the plasma, as well as to control the contact time between the gas to be detected and the plasma, the reaction time between oxygen and the noxious element, and the time needed for transfer to the mass spectrometer of the radio-frequency ICP-MS system. Preferably, the carrier gas is mixed with the gas to be detected before the introduction to the plasma, and the flow rate of the gas is controlled by the flow rate of the carrier gas. Also, the amount of the gas supplied to the plasma is substantially controlled by the flow rate of the gas to be detected before the mixing with the carrier gas.

It is preferred that the carrier gas is an inert gas including argon.

The carrier gas is supplied at a flow rate of 0.8-1 L/min in order to transfer the gas to be detected effectively and to prevent degradation of detection quality caused by collision.

The gas to be detected, introduced to the plasma after the mixing with the carrier gas, is supplied at a flow rate of 1-5 mL/min. Such a flow rate allows efficient generation of the oxide ion of the noxious element within a short time.

Since the method in accordance with the present invention has high accuracy by detecting the oxide ion of the noxious element, there is a linear interrelation (with an intercept of 0) between the concentration of the noxious substance contained in the gas and the signal obtained by detecting the mass of the oxide ion of the noxious element.

More particularly, such a linear interrelation refers to a linear function having an intercept of 0 and including two parameters of the concentration of the noxious substance contained in the gas and the signal.

Preferably, according to one embodiment, the method detects an airborne arsenic compound, the oxide ion of the noxious element is AsO⁺, and the detection with ICP-MS collects the signal at an m/z value of 90.9165 corresponding to the mass (m/z) of AsO⁺.

More particularly, the gas to be detected is supplied at a flow rate of 1-5 mL/min, and the concentration (y) of the noxious substance equals to the signal (x) multiplied by 0.006-0.05, wherein the concentration (y) of the noxious substance is expressed in the unit of μg/m³.

### BRIEF DESCRIPTION OF THE DRAWINGS

FIG. 1 is a schematic view illustrating a system for carrying out the method in accordance with an embodiment of the present invention.

FIG. 2 is a graph illustrating the results of detection signals depending on the arsine concentrations in accordance with an embodiment of the present invention.

FIG. 3 is a graph illustrating the detection signals of arsine gas depending on the flow rates of oxygen gas in accordance with an embodiment of the present invention.

FIG. 4 is a graph illustrating the detection signals of arsine gas depending on the flow rates of carrier gas in accordance with an embodiment of the present invention.

FIG. 5 is a graph illustrating the detection signals of arsine gas depending on the sample introduction flow rates in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. The present invention may, however, be embodied in many different forms and should not be construed as limited to the exemplary embodiments set forth therein. In the drawings, like reference numerals in the drawings denote like elements.

Unless otherwise defined, all terms (including technical and scientific terms) used herein have the same meaning as commonly understood by one of ordinary skill in the art. A detailed description of known functions and configurations incorporated herein will be omitted so as not to obscure the subject matter of the present invention.

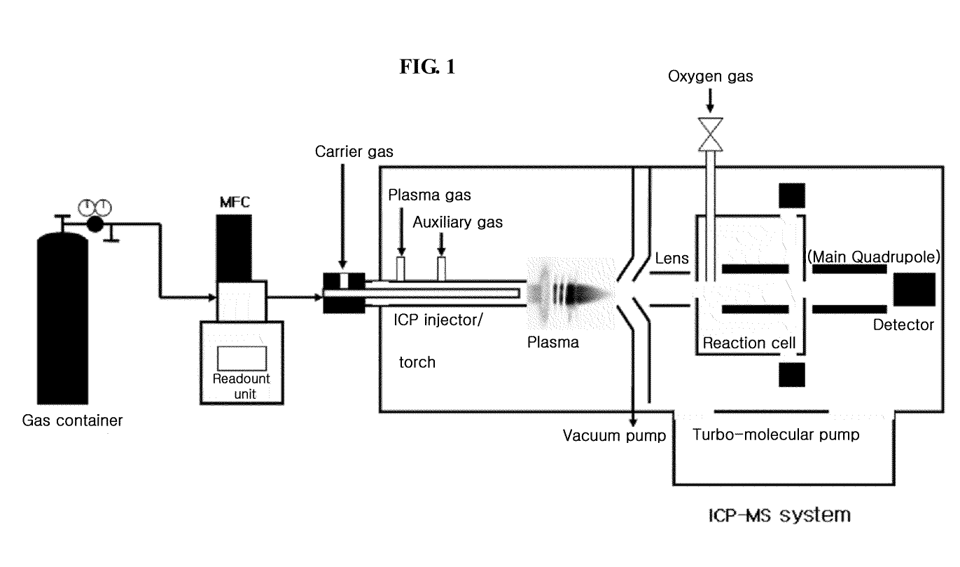

FIG. 1 is a schematic view illustrating a radio-frequency inductive coupled plasma-mass spectroscopy (ICP-MS) system equipped with a reaction cell for carrying out the method in accordance with an embodiment of the present invention. The mass spectrometer as shown in FIG. 1 is a typical example of quadrupole ICP-MS systems, in which ions are detected selectively and separately by a quadrupole depending on the m/Z values of the ions.

As shown in FIG. 1, the system for carrying out the method in accordance with an embodiment of the present invention preferably includes a reaction cell having a fluid supply tube between an ICP injector/torch for generating a plasma by receiving a plasma gas (and a plasma auxiliary gas) and a detector for mass spectrometry. Oxygen gas is supplied to the reaction cell so as to generate the oxide ion of a noxious element contained in the gas to be detected, introduced to the plasma.

The reaction cell preferably provides an oxygen atmosphere by being surrounded with internal partitions except the fluid transfer path between the plasma generated by the ICP injector/torch and the mass spectrometer (detector). Herein, as shown in FIG. 1, the fluid transfer path is formed preferably in the reaction cell so that the gas to be detected, introduced to the ICP-MS system, may be transferred from the plasma and the reaction cell to the detector by way of the shortest path (linear path).

The gas container as shown in FIG. 1 receives the gas as an analyte, and the gas is supplied preferably to the ICP-MS system at a controlled flow rate through a conventional flow rate controller, including a mass flow controller (MFC). Preferably, the gas is supplied to the ICP-MS system together with a carrier gas. The carrier gas and oxygen gas are also supplied preferably at a controlled flow rate through a conventional flow rate controller including an MFC.

The method in accordance with the present invention requires no separate pretreatment for detecting an airborne noxious substance, and uses the ambient air itself as an analyte. However, a nitrogen gas containing a certain concentration of arsine (AsH₃) is used as a gas to be detected in the following examples so that those skilled in the art fully understand the advantages and determination accuracy of the method in accordance with the present invention. Like the system as shown in FIG. 1, a quadrupole ICP-MS system equipped with a reaction cell having an external gas supply line is used. Meanwhile, the inventors of the present invention have found that the flow rate of a sample, that of oxygen gas and that of carrier gas are the factors that affect the detection accuracy significantly. Therefore, the following examples also show that the detection sensitivity depends on such flow rates.

### Example

Argon gas is used as a carrier gas, and oxygen gas with a purity of 99.999% is used.

Three different samples to be analyzed are prepared by mixing arsine (2.63%) in the balance gas of N₂ (available from Daehan GasFill Corporation, Yong-In, South Korea) with high purity N₂ gas, so that three different As concentrations of 161 μg/m³ (49.8 ppbv), 322 μg/m³ (99.7 ppbv), and 645 μg/m³ (199.9 ppbv) are obtained, based on the international guide as defined in ISO 6142.

As an ICP-MS system, a quadrupole ICP-MS system (Sciex Elan 6100 DRC Plus available from Perkin-Elmer), equipped with a reaction cell and having a similar structure to the system as shown in FIG. 1, is used. The flow rates of the carrier gas, oxygen gas and each sample are controlled by an MFC.

The radio-frequency (RF) power and the nebulizer gas flow rate are set to obtain maximum sensitivity, while preventing the formation of double charged ions. The voltage of the cylinder lens, the rod offset voltages of both the quadrupole and the reaction cell, and the Mathieu stability parameters of the quadrupole are set for the maximum ion transmission.

Oxygen gas is supplied at a flow rate of 0.35 mL/min. and each of the three samples having an arsine content of 161 μg/m² (49.8 ppbv), 322 μg/m² (99.7 ppbv), and 645 μg/m² (199.9 ppbv) is supplied at a sample flow rate of 0.2 mL/min or 0.5 mL/min. Argon as a carrier gas is supplied at a flow rate of 0.9 L/min. The mass spectrometer detects signals (intensities) at an m/z value of 90.9165 corresponding to AsO⁺. Herein, detection of the mass of the oxide ion requires a time up to several minutes after supplying the sample gas.

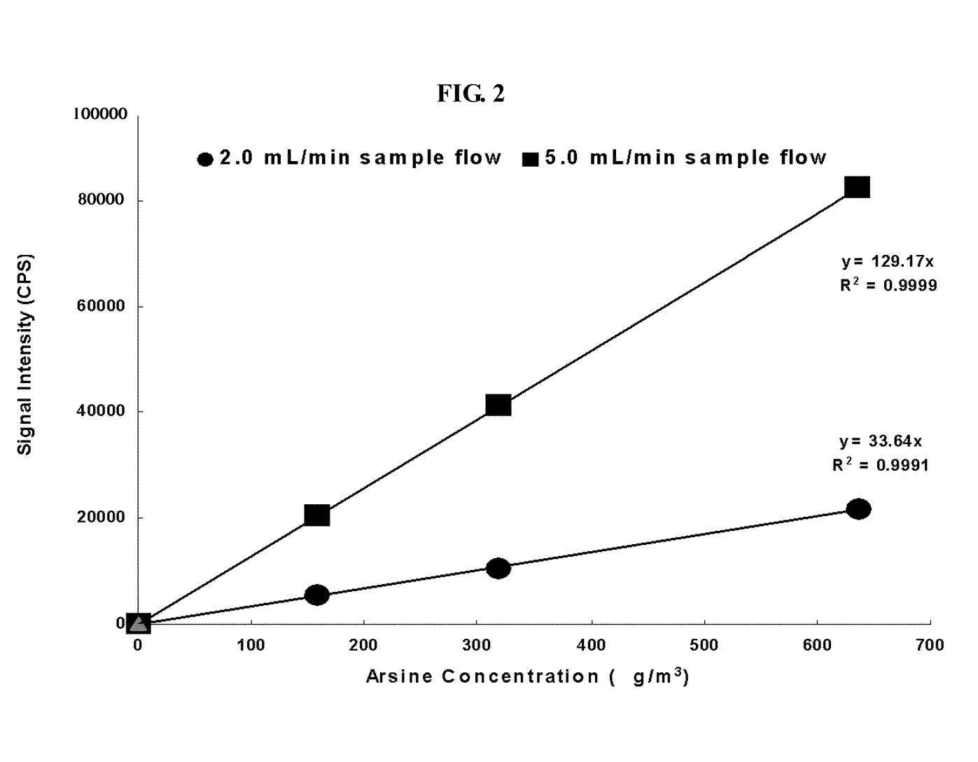

FIG. 2 is a graph illustrating the signal intensities (cps) of ASO⁺ depending on the arsine concentrations in the sample and the sample flow rates. As the sample flow rate increases, the detection signal intensity also increases. It can be seen that there is a linearity (intercept=0) between the arsine content (μg/m²) in the sample and the signal intensity under the same sample flow rate (R²=0.9999: flow rate 0.5 mL/min, and R²=0.9991: flow rate 0.2 mL/min).

As can be seen from FIG. 2, the method in accordance with an embodiment of the present invention detects arsenic oxide ion (AsO⁺: m/z=90.9615) instead of arsenic ion (As⁺: m/z=74.9215) of arsenic or an arsenic compound. Thus, it is possible to avoid the interference caused by other ion species (ArC⁺: m/z=74.9286, CaCl⁺: m/z=74.9314), and to obtain detection signals linearly proportional to the arsine concentration in the gas. As a result, it is possible to determine the arsine concentration with high accuracy.

The detection reliability (reproducibility) is investigated by the results from 5 replicate determinations for each arsine sample with a relative standard deviation (RSD) of 3.9%. This demonstrates that the method in accordance with the present invention detects the amount of a noxious substance contained in a gas with high accuracy and reliability.

The background signals corresponding to noises are determined for 10 replicates and the value for the standard deviation of background (S_{b}) is 5.8 cps. The assigned value (t) of the student's t statistics for 10 replicates tested in this study is 2.262 at 95% confidence level. For the sample flow rate of 5 mL/min, the slope of the calibration curves is 128.86 (cps/(μg/m³), also referred to as ‘m’). With the m value, the minimum detectable concentration is calculated based on the mathematical formula of (C_{DL})=(S_{b}*t)/m. The minimum detectable concentration is approximately 0.10 μg/m³ (0.03 ppbv), in accordance with an embodiment of the present invention. This demonstrates that the method provides high sensitivity, and thus allows detection of a trace amount of airborne noxious substance.

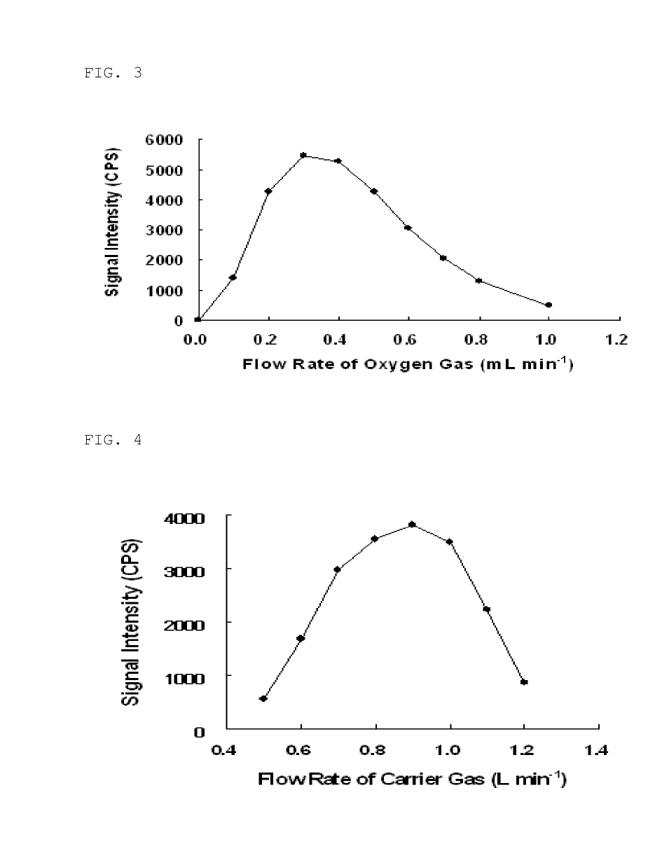

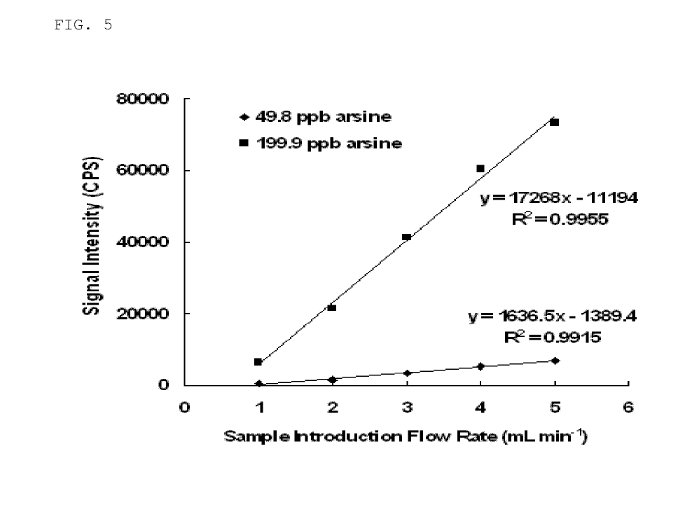

FIGS. 3, 4 and 5 are graphs illustrating the signal intensities depending on the flow rate of oxygen gas (FIG. 3), that of carrier gas (FIG. 4) and that of a sample (FIG. 5), respectively. Preferably, to obtain high detection sensitivity, accuracy and reproducibility, oxygen gas is supplied at a flow rate of 0.2-0.5 mL/min, more preferably 0.3-0.4 mL/min (see FIG. 3), the carrier gas is supplied at a flow rate of 0.8-1 L/min (see FIG. 4), and the gas to be detected is supplied at a flow rate of 1-5 mL/min (see FIG. 5).

Particularly, as shown in FIG. 5, a high linearity is obtained when the flow rate of gas to be detected is 1-5 mL/min, regardless of the arsine concentration in the sample. It can be also seen from the above result that highly accurate and reproducible detection results are obtained under the controlled flow rates of the gas to be detected, carrier gas and oxygen gas, as in the results of FIG. 2.

The method in accordance with the present invention requires no separate pretreatment for detecting an airborne noxious substance, uses the ambient air itself as an analyte, and allows detection of the existence and amount of a noxious substance in a rapid and simple manner with high accuracy. In addition, the method enables detection of a trace amount of noxious substance and real time detection of an airborne noxious substance. More particularly, it is possible to detect arsenic and arsenic compounds as typical airborne noxious substances rapidly and accurately without any pretreatment.

While the present invention has been described with respect to the specific embodiments, it will be apparent to those skilled in the art that various changes and modifications may be made without departing from the spirit and scope of the invention as defined in the following claims.

1. A method for detecting an airborne noxious substance using radio-frequency inductive coupled plasma-mass spectroscopy (ICP-MS), the method comprising:
supplying a gas to be detected to a radio-frequency inductive coupled plasma;
supplying oxygen gas to the gas introduced to the plasma to generate the oxide ion of a noxious element; and
detecting the mass of the oxide ion of the noxious element.

2. The method for detecting an airborne noxious substance according to claim 1, wherein the airborne noxious substance is an arsenic compound, including arsenic hydride, and the oxide ion of the noxious element is AsO⁺.

3. The method for detecting an airborne noxious substance according to claim 2, which is carried out in a continuous and repetitive mode, and allows real time detection of the airborne noxious substance.

4. The method for detecting an airborne noxious substance according to claim 1, wherein the oxygen gas is supplied at a flow rate of 0.2-0.5 mL/min.

5. The method for detecting an airborne noxious substance according to claim 1, wherein the gas to be detected is supplied together with a carrier gas, and the carrier gas is supplied at a flow rate of 0.8-1 L/min.

6. The method for detecting an airborne noxious substance according to claim 5, wherein the gas to be detected is supplied at a flow rate of 1-5 mL/min.

7. The method for detecting an airborne noxious substance according to claim 2, wherein a linear interrelation with an intercept of 0 exists between the concentration of the airborne noxious substance and the signal obtained by detecting the mass of the oxide ion of the noxious element.

8. The method for detecting an airborne noxious substance according to claim 7, wherein the gas to be detected is supplied at a flow rate of 1-5 mL/min, and the concentration (y) of the noxious substance equals to the signal (x) multiplied by 0.006-0.05.
